(19) United States
(12) Patent Application Publication
(10) Pub. No.: US 2026/0332556 A1
(43) Pub. Date: Oct. 22, 2026

(54) Secure Traffic Steering Through a Cloud-Based System Using Encrypted Client Hello (ECH)

(71) Applicant: Zscaler, Inc., San Jose, CA (US)

(72) Inventor: Yaroslav Rosomakho, Thatcham (GB)

(73) Assignee: Zscaler, Inc., San Jose, CA (US)

(21) Appl. No.: 19/185,646

(22) Filed: Apr. 22, 2025

(51) Int. Cl. H04L 9/40

(52) U.S. Cl. CPC H04L 63/0236; H04L 63/0435; H04L 63/083; H04L 63/1425; H04L 63/166

(57) ABSTRACT

Systems and methods for securely steering traffic through a cloud-based system using Encrypted Client Hello (ECH) include receiving Domain Name System (DNS) queries from a user device; providing, in response to the DNS queries, IP addresses of at least one proxy node in a cloud environment and ECH information including a user-specific public key and an ephemeral public Server Name Indication (SNI); decrypting an encrypted portion of a TLS Client Hello message using the user-specific public key to validate a user identity and determine an actual destination address; and routing user traffic to the actual destination address based on the validated user identity.

### FIELD OF THE DISCLOSURE

The present disclosure generally relates to network and cloud security. More particularly, the present disclosure relates to systems and methods for securely steering traffic through a cloud-based system using Encrypted Client Hello (ECH).

### BACKGROUND OF THE DISCLOSURE

Encrypted Client Hello (ECH) is a recent extension to the Transport Layer Security (TLS) protocol designed to encrypt sensitive information, particularly the Server Name Indication (SNI), in the Client Hello message. While this improves user privacy by preventing unauthorized intermediaries from discovering the actual hostname a user is visiting, it also makes it significantly more difficult for legitimate network security services, such as proxies and firewalls, to identify users and their intended destinations. In traditional TLS connections, network appliances could rely on the cleartext SNI to categorize, log, or enforce policies on user traffic. With ECH, these appliances lose visibility into the destination domain unless they have specific insight into the encrypted SNI. Consequently, organizations struggle to maintain user identification and ensure policy compliance without undermining the privacy benefits offered by ECH. This challenge is heightened in complex cloud-based environments where multiple identity solutions, devices, and communication channels are in play. The invention described herein addresses these difficulties by integrating a secure and privacy-preserving process that reliably signals user identity and intended destination despite ECH-based encryption.

### BRIEF SUMMARY OF THE DISCLOSURE

The present disclosure relates to systems and methods for securely steering traffic through a cloud-based system using ECH. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving Domain Name System (DNS) queries from a user device; providing, in response to the DNS queries, IP addresses of at least one proxy node in a cloud environment and ECH information including a user-specific public key and an ephemeral public Server Name Indication (SNI); decrypting an encrypted portion of a TLS Client Hello message using the user-specific public key to validate a user identity and determine an actual destination address; and routing user traffic to the actual destination address based on the validated user identity.

The steps can further include wherein the receiving and providing are performed by a Secure Service Edge (SSE) service of the cloud-based system, and wherein the decrypting and routing are performed by the at least one proxy node. The steps can include assigning each of a plurality of users of a tenant a unique DNS over Hypertext Transfer Protocol Secure (HTTPS) (DoH) Uniform Resource Locator (URL) that is associated exclusively with each user. The received DNS queries can be directed to a unique DoH URL. The steps can include authenticating the user device prior to assigning the unique DoH URL, wherein the authenticating includes validating one or more user credentials. A unique DoH URL can be generated by a cloud-based management service that dynamically provisions DoH URLs on a per-user basis in response to user enrollment events. Prior to the decrypting, the steps can include establishing a Transport Layer Security (TLS) connection with the at least one proxy node using the ephemeral public SNI in a TLS Client Hello message. The steps can include monitoring user traffic at the at least one proxy node for one or more security threats or policy violations, and blocking or quarantining traffic that is determined to be malicious or non-compliant. Providing the IP addresses of at least one proxy node can be based on geographical proximity of the user device to optimize performance. The steps can include generating the ephemeral public SNI at predetermined intervals such that a newly generated ephemeral public SNI can be used to enhance user privacy and security.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flowchart of a process for securely steering traffic through a cloud-based system using Encrypted Client Hello (ECH).

### DETAILED DESCRIPTION OF THE DISCLOSURE

Again, the present invention provides systems and methods to reliably identify users in cloud-based environments that employ Encrypted Client Hello (ECH) for enhanced privacy. Rather than relying on legacy techniques that expose the Server Name Indication (SNI) or require cumbersome certificate management, this invention assigns each user a unique DNS over HTTPS (DoH) URL and delivers per-user ECH information. When a user initiates a secure connection, the system embeds an ephemeral public SNI and user-specific public key within the HTTPS DNS records. A proxy node then decrypts the ECH to determine both the true user identity and the intended destination. This approach maintains ECH’s privacy advantages while ensuring granular visibility and control for network security and policy enforcement in cloud-based environments.

### 1.0 Cybersecurity Monitoring and Protection Examples

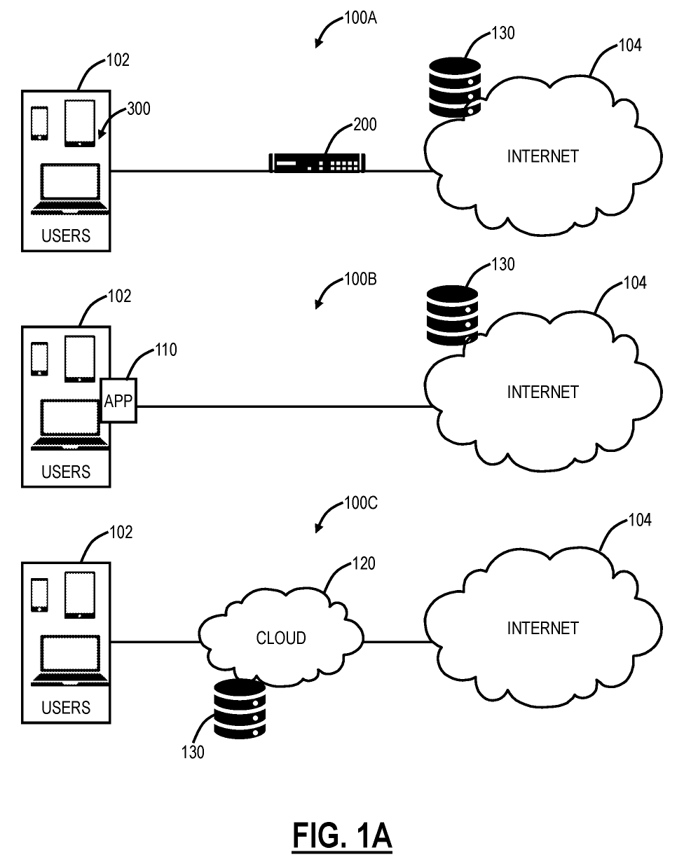

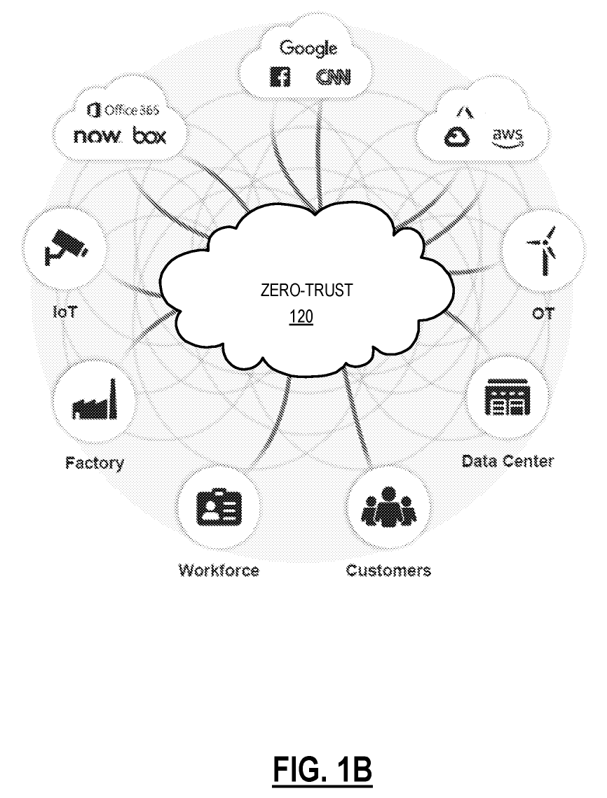

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

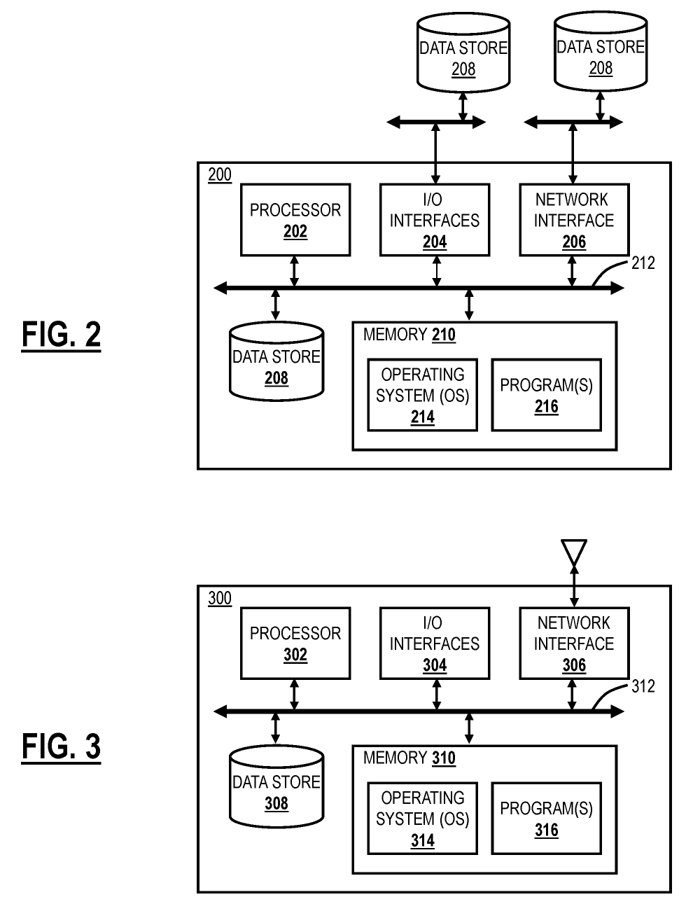

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer’s data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection:
   Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies:
   Zero trust policies verify access requests and rights based on context, including user identity, device, location, type of content, and the application being requested. Policies are adaptive, so user access privileges are continually reassessed as context changes.
Reduce risk by eliminating the attack surface:
   With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:
Commonly-assigned U.S. Patent No. 8,429,111, issued Apr. 23, 2013, and entitled “Encoding and compression of statistical data,” the contents of which are incorporated herein by reference, describes compression techniques for storing such logs,
Commonly-assigned U.S. Patent No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and
Commonly-assigned U.S. Patent Application No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user’s 102 activity. That is, the log data 130 is not merely confined to specific activity (e.g., a user’s 102 social networking activity on a specific site, a user’s 102 search requests on a specific search engine, etc.).

### 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

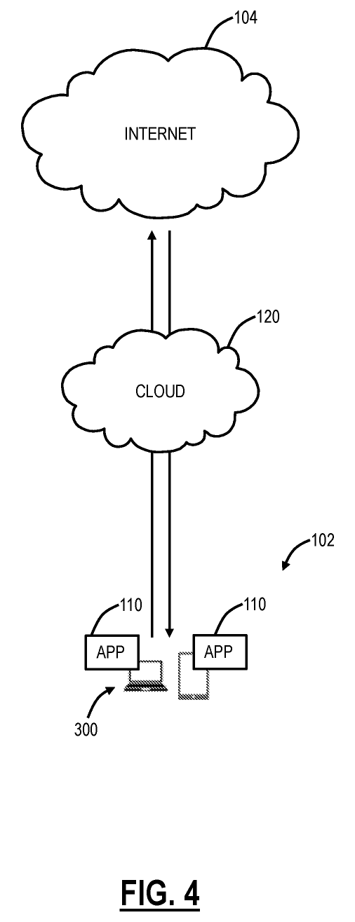

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best-in-class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### 5.0 User Identification via Encrypted Client Hello

The present disclosure relates to systems and methods for recognizing user identities within cloud environments utilizing Encrypted Client Hello (ECH). Ensuring the secure and reliable identification of users accessing web proxy services has consistently posed significant challenges for IT administrators and security professionals. Various methods have been employed to address this issue, each with its own set of advantages and limitations that impact their practicality and effectiveness in diverse environments.

One approach involves providing users with specialized software, such as the agent application 110 described herein. These agent applications 110 are designed to authenticate users 102 by leveraging secure credentials and ensuring that only authorized individuals can access web proxy services. This method can be highly effective in maintaining security and ensuring user identification. However, it necessitates the deployment and ongoing maintenance of additional software. This process can be resource-intensive, requiring IT teams to manage installations, updates, and troubleshooting across numerous devices. Additionally, agent applications 110 can only be installed on platforms that are compatible and supported, which can be a significant limitation in heterogeneous IT environments where users 102 operate on various operating systems and devices.

Another method involves enrolling users 102 with digital certificates. Digital certificates serve as a means of verifying user identity through cryptographic credentials issued by a Certificate Authority (CA). While this method provides a high level of security and can be integrated into various authentication frameworks, it relies on a complex enterprise CA infrastructure for certificate issuance and ongoing maintenance. Managing this infrastructure can be cumbersome and resource-intensive, involving processes such as generating, distributing, and renewing certificates. Furthermore, the process of enrolling and managing certificates can be technically challenging, requiring specialized knowledge and infrastructure. This complexity can be a significant barrier for organizations, particularly those with limited IT resources or expertise.

A third method utilizes identity providers with a cookie surrogate approach to authenticate users. This approach leverages cookies to store authentication information, allowing users to be identified without the need for additional software or certificates. The use of cookies enables seamless integration with web browsers and can simplify the authentication process for end-users. However, this method is inherently limited to web browsers that support cookies, which restricts its applicability in environments where multiple types of clients and devices are in use. For instance, non-browser applications or devices that do not support cookies cannot leverage this authentication method, thereby limiting its effectiveness and coverage.

In summary, while there are several methods available for the secure and reliable identification of users accessing web proxy services, each comes with its own set of practical drawbacks. The deployment and maintenance of additional software, the complexity of enterprise CA enrolment and maintenance, and the limitations of cookie-based authentication highlight the ongoing challenges faced in this area. Organizations must weigh the benefits and limitations of each method to determine the most suitable approach for their specific needs and environments. Balancing security, ease of use, and manageability remains a critical consideration as they strive to protect their networks and ensure that only authorized users can access their web proxy services.

ECH is an innovative extension to the Transport Layer Security (TLS) protocol, which has been developed to significantly enhance user privacy by encrypting sensitive portions of the TLS Client Hello message. Traditionally, the Client Hello message, which initiates the TLS handshake, includes various pieces of information in plaintext, such as the Server Name Indication (SNI). The SNI reveals the specific hostname the client intends to connect to, which can be exploited by intermediaries to monitor, censor, or manipulate user traffic. ECH addresses this privacy concern by encapsulating the SNI and other sensitive data within an encrypted extension, thereby preventing unauthorized entities from accessing this information.

To enable this encryption, the client must first obtain the necessary public encryption key. This is accomplished through an additional DNS lookup for an HTTPS record, as specified in RFC 9460. The HTTPS DNS record is a critical component in the ECH process, as it provides the client with essential details required for secure communication. Specifically, this DNS record contains the public key that the client will use to encrypt the Client Hello message. Additionally, it includes a list of supported cryptographic algorithms, which ensures compatibility between the client and the server during the encryption process. The record also includes a public name, which the client incorporates into the clear text portion of the SNI. This allows the server to be correctly identified and ensures that the connection can be established without exposing the sensitive details of the intended destination.

The process of performing this extra DNS lookup for the HTTPS record is a crucial step in the ECH mechanism. By acquiring the public key and other necessary information, the client is equipped to generate an encrypted Client Hello message that shields the SNI and other sensitive data from prying eyes. This additional layer of encryption enhances the overall security and privacy of the TLS handshake, making it much more difficult for intermediaries to intercept or tamper with the connection.

The implementation of ECH represents a significant advancement in the field of internet security and privacy. By encrypting the Client Hello message, ECH mitigates the risks associated with plaintext transmission of sensitive information during the initial stages of a TLS connection. This innovation is particularly important in an era where online privacy is increasingly threatened by sophisticated surveillance and data interception techniques. ECH helps to ensure that users can maintain their privacy and security when accessing online services, protecting them from potential eavesdropping and malicious interference.

Furthermore, the adoption of ECH has broader implications for the future of secure internet communications. As more servers and clients begin to support this extension, it is expected to become a standard practice, raising the overall security baseline for internet connections. This widespread adoption will contribute to a more secure and private online environment, benefiting users, service providers, and the internet ecosystem as a whole.

In summary, Encrypted Client Hello (ECH) is a groundbreaking extension to the TLS protocol that enhances user privacy by encrypting sensitive portions of the Client Hello message, such as the Server Name Indication (SNI). By leveraging an additional DNS lookup for an HTTPS record, clients can obtain the necessary public key and other information required for encryption. This process ensures that sensitive data remains protected during the TLS handshake, significantly improving the security and privacy of internet communications. The implementation and adoption of ECH mark a critical step forward in safeguarding user privacy and fortifying the overall integrity of online interactions.

The cloud-based system, i.e., the cloud 120, can effectively leverage the ECH mechanism to reliably signal user identity through a detailed process that ensures both security and uniqueness. In order to facilitate this process, first, each user is assigned a unique DNS over HTTPS (DoH) URL. This URL is an integral part of the Secure Service Edge (SSE) service and is specifically tailored to each individual user, ensuring that it is not shared with anyone else. This unique URL acts as a personalized gateway for handling the user’s DNS queries securely.

Secure Service Edge (SSE) is a cloud-based security framework designed to provide comprehensive protection and secure access to internet and cloud-based resources. SSE integrates a variety of security services, including Secure Web Gateway (SWG), Cloud Access Security Broker (CASB), and Zero Trust Network Access (ZTNA), into a unified platform. This approach ensures that users, regardless of their location or device, can securely access applications and data without compromising on security.

SSE leverages advanced technologies such as encryption, threat intelligence, and user identity verification to protect against cyber threats and data breaches. It enables organizations to enforce consistent security policies, monitor user activity, and ensure compliance with regulatory requirements. By centralizing security controls in the cloud, SSE simplifies the management of security infrastructure, reduces the complexity of traditional network security models, and enhances the overall security posture of an organization.

Based thereon, when a user attempts to open a website, their browser sends DNS, A, and AAAA queries, and HTTPS records to this unique DoH URL. The SSE service responds to these queries in a specific manner to facilitate secure and efficient connections. For the A and AAAA requests, the service provides the IPv4 and IPv6 addresses of the closest proxy node, ensuring optimal routing of the user’s traffic. In various embodiments, proxy nodes are nodes, servers 200, virtual machines, etc. of the cloud 120. The response to the HTTPS DNS query is more complex and includes the ECH information. This information contains a unique per-user public key and an ephemeral public SNI. The ephemeral public SNI is crucial because it uniquely identifies the user while keeping their sensitive identity information secure.

Following this, the user’s browser establishes a connection to the provided proxy IP address. During this connection establishment, the initial TLS Client Hello message includes the public SNI, which can be used to identify the user. The proxy node then decrypts the ECH extension to validate the user’s identity and determine the actual destination of the transaction. By decrypting this information, the proxy node ensures that the user is authenticated and that their request is securely routed to the intended destination.

This process not only enhances the security and privacy of the user by utilizing encrypted identifiers and secure DNS queries but also ensures efficient and reliable user identification through unique DoH URLs and sophisticated TLS handshake mechanisms. By integrating these steps within the cloud-based system, a robust and secure method for signaling user identity is established, which is essential for maintaining the integrity and privacy of user interactions in a cloud environment.

More specifically, in relation to the cloud 120, the process includes the following:

Provisioning Unique DNS over HTTPS URL: Each user within the cloud 120 system is provisioned with a unique DNS over HTTPS (DoH) URL. This URL is specifically assigned to the individual user and is an integral part of the SSE service. It ensures that each user has a personalized and exclusive gateway for their DNS queries, which is not shared with any other user.

Sending DNS Queries: When the user attempts to access a website, their browser sends DNS queries to this unique DoH URL. These queries include requests for A, AAAA, and HTTPS records. The A and AAAA requests are used to resolve the IPv4 and IPv6 addresses, respectively, while the HTTPS request is used to obtain additional information necessary for the ECH process.

SSE Service Response: The SSE service responds to the A and AAAA DNS queries by providing the IPv4 and IPv6 addresses of the closest proxy node. This ensures that the user’s traffic is routed through the most optimal path, enhancing performance and reducing latency.

For the HTTPS DNS query, the SSE service provides a more detailed response that includes ECH information. This information contains a unique per-user public key and an ephemeral public SNI. The ephemeral SNI is crucial as it uniquely identifies the user without exposing sensitive details, thereby preserving privacy.

Establishing Connection: The user’s browser then establishes a connection to the provided proxy IP address. During this process, the initial TLS Client Hello message, which is part of the TLS handshake, includes the public SNI. This public SNI can be used by the proxy to identify the user initially.

Decrypting Encrypted Client Hello: The proxy node receives the TLS Client Hello message and decrypts the ECH extension using the unique per-user public key provided in the HTTPS DNS response. This decryption process allows the proxy to validate the user’s identity securely. It also reveals the actual intended destination of the user’s request, ensuring that the transaction can be routed correctly.

User Authentication and Secure Routing: By decrypting the ECH, the cloud 120 proxy can authenticate the user and determine the actual web resource they are trying to access. This ensures that only legitimate users can access the network, and their requests are securely and accurately directed to the intended destination.

With the user's identity validated and the destination identified, the proxy can then securely route the user's web traffic to the intended destination. This routing is done through the most efficient and secure path available, leveraging the cloud 120 global network infrastructure. Throughout the session, the cloud 120 continuously monitors the user's activity for any signs of malicious behavior or policy violations. Security policies are enforced consistently, ensuring that the user's web traffic remains secure and compliant with organizational requirements.

The ECH mechanism within the cloud 120 architecture provides a robust and secure method for identifying users while maintaining their privacy. By utilizing unique DoH URLs, encrypted identifiers, and sophisticated decryption processes, Zscaler ensures that user identity is reliably signaled and authenticated, enhancing both security and user experience in accessing web resources.

### 5.1 Process for User Identification via Encrypted Client Hello

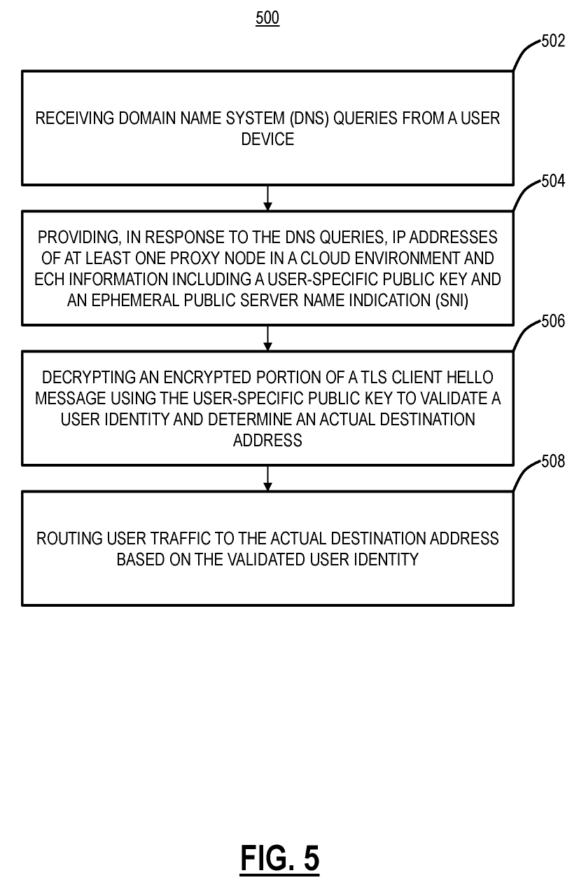

FIG. 5 is a flowchart of a process 500 for securely steering traffic through a cloud-based system using Encrypted Client Hello (ECH). In various embodiments, the process 500 includes a method having steps, a processing device configured to implement the steps, a cloud-based system configured to implement the steps, and as a non-transitory computer-readable medium storing instructions for programming one or more processors to execute the steps. The process 500 includes receiving Domain Name System (DNS) queries from a user device (step 502); providing, in response to the DNS queries, IP addresses of at least one proxy node in a cloud environment and ECH information including a user-specific public key and an ephemeral public Server Name Indication (SNI) (step 504); decrypting an encrypted portion of a TLS Client Hello message using the user-specific public key to validate a user identity and determine an actual destination address (step 506); and routing user traffic to the actual destination address based on the validated user identity (step 508).

The process 500 can further include wherein the receiving and providing are performed by a Secure Service Edge (SSE) service of the cloud-based system, and wherein the decrypting and routing are performed by the at least one proxy node. The steps can include assigning each of a plurality of users of a tenant a unique DNS over Hypertext Transfer Protocol Secure (HTTPS) (DoH) Uniform Resource Locator (URL) that is associated exclusively with each user. The received DNS queries can be directed to a unique DoH URL. The steps can include authenticating the user device prior to assigning the unique DoH URL, wherein the authenticating includes validating one or more user credentials. A unique DoH URL can be generated by a cloud-based management service that dynamically provisions DoH URLs on a per-user basis in response to user enrollment events. Prior to the decrypting, the steps can include establishing a Transport Layer Security (TLS) connection with the at least one proxy node using the ephemeral public SNI in a TLS Client Hello message. The steps can include monitoring user traffic at the at least one proxy node for one or more security threats or policy violations, and blocking or quarantining traffic that is determined to be malicious or non-compliant. Providing the IP addresses of at least one proxy node can be based on geographical proximity of the user device to optimize performance. The steps can include generating the ephemeral public SNI at predetermined intervals such that a newly generated ephemeral public SNI can be used to enhance user privacy and security.

### 6.0 Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method for securely steering traffic through a cloud-based system using Encrypted Client Hello (ECH), the method comprising steps of:
receiving Domain Name System (DNS) queries from a user device;
providing, in response to the DNS queries, IP addresses of at least one proxy node in a cloud environment and ECH information including a user-specific public key and an ephemeral public Server Name Indication (SNI);
decrypting an encrypted portion of a TLS Client Hello message using the user-specific public key to validate a user identity and determine an actual destination address; and
routing user traffic to the actual destination address based on the validated user identity.

2. The method of claim 1, wherein the receiving and providing are performed by a Secure Service Edge (SSE) service of the cloud-based system, and wherein the decrypting and routing are performed by the at least one proxy node.

3. The method of claim 1, wherein the steps comprise:
assigning each of a plurality of users of a tenant a unique DNS over Hypertext Transfer Protocol Secure (HTTPS) (DoH) Uniform Resource Locator (URL) that is associated exclusively with each user.

4. The method of claim 3, wherein the received DNS queries are directed to a unique DoH URL.

5. The method of claim 3, further comprising authenticating the user device prior to assigning the unique DoH URL, wherein the authenticating includes validating one or more user credentials.

6. The method of claim 3, wherein a unique DoH URL is generated by a cloud-based management service that dynamically provisions DoH URLs on a per-user basis in response to user enrollment events.

7. The method of claim 1, wherein prior to the decrypting, the steps include establishing a Transport Layer Security (TLS) connection with the at least one proxy node using the ephemeral public SNI in a TLS Client Hello message.

8. The method of claim 1, further comprising monitoring user traffic at the at least one proxy node for one or more security threats or policy violations, and blocking or quarantining traffic that is determined to be malicious or non-compliant.

9. The method of claim 1, wherein providing the IP addresses of at least one proxy node is based on geographical proximity of the user device to optimize performance.

10. The method of claim 1, further comprising generating the ephemeral public SNI at predetermined intervals such that a newly generated ephemeral public SNI can be used to enhance user privacy and security.

11. A non-transitory computer-readable medium comprising instructions for securely steering traffic through a cloud-based system using Encrypted Client Hello (ECH) that, when executed, cause one or more processors to perform steps of:
receiving Domain Name System (DNS) queries from a user device;
providing, in response to the DNS queries, IP addresses of at least one proxy node in a cloud environment and ECH information including a user-specific public key and an ephemeral public Server Name Indication (SNI);
decrypting an encrypted portion of a TLS Client Hello message using the user-specific public key to validate a user identity and determine an actual destination address; and
routing user traffic to the actual destination address based on the validated user identity.

12. The non-transitory computer-readable medium of claim 11, wherein the receiving and providing are performed by a Secure Service Edge (SSE) service of the cloud-based system, and wherein the decrypting and routing are performed by the at least one proxy node.

13. The non-transitory computer-readable medium of claim 11, wherein the steps comprise:
assigning each of a plurality of users of a tenant a unique DNS over Hypertext Transfer Protocol Secure (HTTPS) (DoH) Uniform Resource Locator (URL) that is associated exclusively with each user.

14. The non-transitory computer-readable medium of claim 13, wherein the received DNS queries are directed to a unique DoH URL.

15. The non-transitory computer-readable medium of claim 13, further comprising authenticating the user device prior to assigning the unique DoH URL, wherein the authenticating includes validating one or more user credentials.

16. The non-transitory computer-readable medium of claim 13, wherein a unique DoH URL is generated by a cloud-based management service that dynamically provisions DoH URLs on a per-user basis in response to user enrollment events.

17. The non-transitory computer-readable medium of claim 11, wherein prior to the decrypting, the steps include establishing a Transport Layer Security (TLS) connection with the at least one proxy node using the ephemeral public SNI in a TLS Client Hello message.

18. The non-transitory computer-readable medium of claim 11, further comprising monitoring user traffic at the at least one proxy node for one or more security threats or policy violations, and blocking or quarantining traffic that is determined to be malicious or non-compliant.

19. The non-transitory computer-readable medium of claim 11, wherein providing the IP addresses of at least one proxy node is based on geographical proximity of the user device to optimize performance.

20. The non-transitory computer-readable medium of claim 11, further comprising generating the ephemeral public SNI at predetermined intervals such that a newly generated ephemeral public SNI can be used to enhance user privacy and security.
